(19) United States
(12) Patent Application Publication
(10) Pub. No.: US 2024/0405792 A1
(43) Pub. Date: Dec. 5, 2024

(54) Two-Piece Exoskeleton for a Mobile Computing Device

(71) Applicant: ZEBRA TECHNOLOGIES CORPORATION, LINCOLNSHIRE, IL (US)

(72) Inventors: Michele B. Feinstein, Oceanside, NY (US); Chi-Ming Wang, Taipei (TW)

(21) Appl. No.: 18/205,779

(22) Filed: Jun. 5, 2023

(51) Int. Cl. H04B 1/3888

(52) U.S. Cl. CPC H04B 1/3888

(57) ABSTRACT

An example disclosed protective shell for a device includes a first housing and a second housing. The first housing including a front perimeter edge, a side wall adjacent to the front perimeter edge, at least one recess area adjacent to a ledge, and at least one guide rail. The second housing including at least one tab and at least one receiving rail. The first housing and the second housing combine to secure the device by meshing the at least one guide rail and the at least one receiving rail, and securing the at least one tab to the ledge such that the tab is located within the at least one recess.

### BACKGROUND OF THE INVENTION

As mobile communication devices, PDAs, tablets and other consumer electronic devices have become commonplace, so have the various exoskeleton shells used to protect those devices. Shells seek to encase and protect the devices while maintaining the integrity of the shells over repeated installation and removal.

### SUMMARY

In an embodiment, the present disclosure is a protective shell for a device, the protective shell comprising: a first housing comprising: a front perimeter edge, a side wall adjacent to the front perimeter edge, at least one recess area adjacent to at least one ledge, and at least one guide rail; and a second housing comprising at least one tab and at least one receiving rail; wherein the first housing and the second housing combine to secure the device by: meshing the at least one guide rail and the at least one receiving rail, and securing the at least one tab to the at least one ledge such that the tab is located within the at least one recess area.

In a further embodiment, the present disclosure is a shell to protect a device, the shell comprising: a first housing surrounding a front display of the device; and a second housing configured to releasably connect to the first housing such that the device is secured within the shell when the second housing is connected to the first housing.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an isometric view of the shell according to example embodiments of the present disclosure;

FIG. 2 illustrates an exploded, isometric view of a first housing and a second housing according to example embodiments of the present disclosure;

FIG. 3 illustrates a cross sectional view from a section of FIG. 1 to emphasize a connection area according to an example embodiment of the present disclosure;

FIG. 4A illustrates a front view of the shell according to example embodiments of the present disclosure;

FIG. 4B illustrates a rear view according to example embodiments of the present disclosure; and

FIG. 5 illustrates a cross section of the shell along a line designated in FIG. 4A according to example embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

The disclosed embodiments will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout.

Exoskeleton shells may be used for devices because of a device's thin form factor that requires additional protection. Shells made of flexible material stretch easily and over time may become deformed through absorption of cleaning chemicals and hand oils. Once shells are deformed, they no longer remain in place or provide protection. An alternative is to use a more rigid shell design that relies more on plastic than rubber to offer support. However, said shells must be deformed or bent to be removed. Often, rubber seams are added to provide a little flexibility, but the rubber fails over time, leading to the same problems.

Furthermore, the rigid, single-body shell is often difficult to manufacture due to the need for undercut areas in the design to secure the device within the shell. Sometimes these shells may be permanently deformed during the manufacturing process to remove them from the injection mold thus limiting their functionality. A two-part shell allows the design to use a full rigid plastic ring of protection along the circumference of the device while still being easily removable from the injection mold, and is not prone to losing structural integrity over time due to failures in the rubber. The opening on one end of each housing of the two-part shell provides room for the tool to move and eject from the shell during manufacturing. Since the design allows for easy removal, rubber or flexible material sections are no longer relied on to provide flexibility to the design, and the failures associated with these materials no longer impact product life. Rubber sections may be used in some areas for shock protection, but these rubber sections rely on the plastic sections to secure them into place, so even if the rubber sections wear over time, the overall structural integrity of the shell should remain intact. As described herein, the rubber sections are not intended to add flexibility to the shell.

As described herein, it is desired to have a slim exoskeleton that comes in two parts for easy installation, and yet is rigid enough to protect the encased device, and that could be easily formed by injection molding. What is described below includes a first exoskeleton housing, having a rigid perimeter for the front half of a device and a second housing that covers the back half of the device. The first housing and the second housing have rigid connections through various interlocking hooks and guide rails that provide additional rigidity while helping guide installation.

Mobile computing devices (MCD), or devices, may be configured to capture data via a scan window located on the device. When a device is installed in the shell, it is necessary that the device have clear fields-of-view (FOV). The shell needs to fit around the device and be modeled such that the FOV is clear and a user interface of the device is free to use.

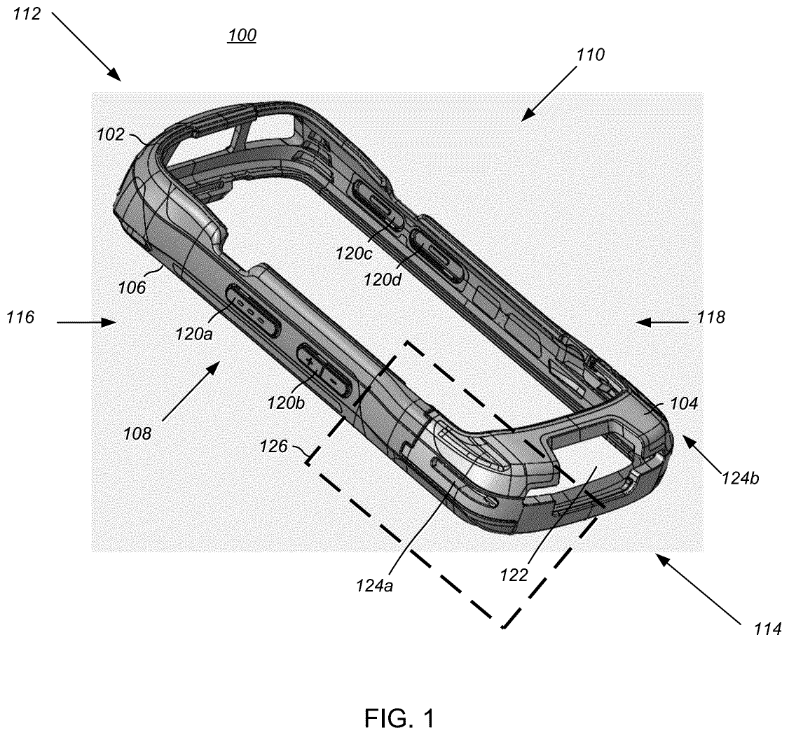

FIG. 1 illustrates an exoskeleton shell 100 (“shell”) according to an example embodiment of this disclosure. The shell 100 includes two separate sections: a first housing 102 and a second housing 104. The first housing 102 and the second housing 104 are removably secured to each other to form the shell 100.

In the illustrated embodiment, the first housing 102 is larger than the second housing 104, however in other embodiments the difference in size may be different than as illustrated. The first housing 102 is structurally formed such that the first housing 102 has a front perimeter edge 106 that encircles the entirety of a front interface of a device, other design elements for the first housing 102 will be described in further detail below.

In the illustrated embodiment of FIG. 1, the shell 100 includes a front side 108, a rear side 110, a top side 112, a bottom side 114, a first side 116, and a second side 118, wherein the front side 108 and the rear side 110 are opposite, the top side 112 and the bottom side 114 are opposite and the first side 116 and the second side 118 are opposite.

Further, in FIG. 1, button elements 120a, 120b, 120c, and 120d are located on the first side 116 and the second side 118, where button elements 120a and 120b are located on the first side 116 and button elements 120c and 120d are located on the second side 118. The button elements 120 are configured to align with corresponding buttons on the device when the device is secured within the shell 100, such that when the button elements 120 are pressed, the button elements 120 translate the press to the corresponding button of the device.

Further, in FIG. 1, an opening 122 is located on the bottom side 114 of the shell 100, the opening 122 formed within the second housing 104. The opening 122 allows for access to ports of the device when the device is secured within the shell 100.

FIG. 1 further illustrates guidance rails 124a and 124b. The guidance rails 124a and 124b (guidance rails 124 collectively) may be used when loading the device and the shell into a charging cradle. The guidance rails 124 help direct the device secured within the shell 100 into a proper path to ensure the shell and device are properly docked in the charging cradle for charging of the device battery or data transfer.

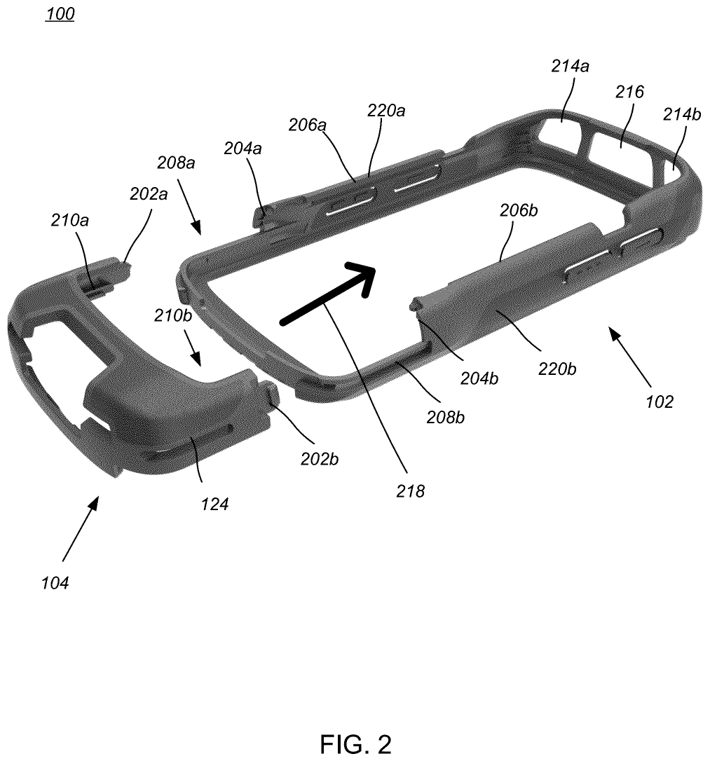

FIG. 2 illustrates a disassembled view of the shell 100 of FIG. 1. In this view, the first housing 102 and the second housing 104 are separate for illustrative purposes. The second housing 104 includes tabs 202a/202b (collectively tabs 202), where each tab 202 features a protrusion from the end of the tab 202. The first housing 102 includes recess 204a/204b (collectively recesses 204.) The interactivity of the tabs 202 and the recesses 204 will be discussed in further detail below. In other embodiments, the tabs 202 are depicted on the first housing 102 and the recesses are on the second housing 104. The area where the tabs and recesses join is also referred to herein as a connection area.

The first housing 102 further include apertures 214a, 214b, and scan window 216. The aperture 214a and aperture 216b are located on the top side 112 of the shell 100 such that the aperture 214a and 214b are configured to align with features that may be located on the top of the device. Possible features on the top of the device include power buttons, speakers, audio ports, microphones, or other possible features that require a user to be able to access while the device is secured in the shell 100. The scan window 216 is depicted as being centrally located on the top side 112 of the first housing 102. The scan window 216 is configured to align with a top scanner of the device. The scanner of the device may be used to capture data from an environment, the data including barcodes, images, or similar data obtained in data collection. The scan window 216 allows the field of view of the scanner to not be impeded by the first housing 102 while still protecting the top side of the device.

As illustrated in FIG. 2, the first housing 102 includes a first area 206a located on the first wall 220a and a second area 206b located on the second wall 220b. As will be described in further detail below, the areas 206 are configured such that when the shell 100 is to be removed from the device, a user may apply pressure using their fingers to flex the walls 220 of the first housing 102 outward to allow the ledge 300 to disengage from the tab 202.

As illustrated in FIG. 2, when securing a device into the shell 100, the device is inserted into the first housing 102 in the direction indicated by arrow 218. The device is inserted such that the user interface, e.g. main screen or display, aligns with the front side 108 of the first housing 102. This alignment is important as it allows the perimeter of the front side of the front housing 102 to be fully aligned with the perimeter of the device. The perimeter of the front housing 102 provides a structural framework that lends to the rigidity of the shell 100. Once the device is loaded into the first housing 102, the second housing 104 can be installed to secure the device into place.

As illustrated in FIG. 2, when securing the second housing 104, guide rails 208 of the first housing 102 align with receiving rails 210 of the second housing 104. The guide rails 208 and the receiving rails 210 are configured to be complementary such that the guide rails 208 and the receiving rails 210 inter-mesh during installation of the second housing 104 onto the first housing 102. The rails 208/210 allow for the first housing 102 and the second housing 104 to be aligned during securement of the shell 100.

As the second housing 104 is installed onto the device and secures to the first housing 102, the tabs 202 of the second housing 104 slide along the sides of the device and underneath walls 220 of the first housing 102. When the tabs 202 slide against the inside of the sidewalls of the first housing 102, the tab 202 passes over the ledge 300 and into the recess 204.

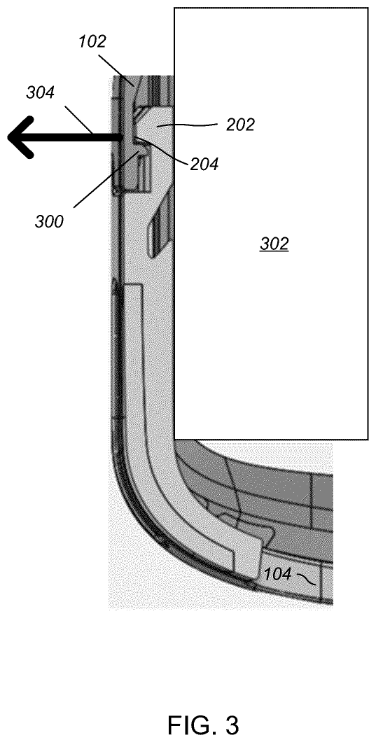

FIG. 3 illustrates a cross-sectional view of section 126 from FIG. 1. Element 302 of FIG. 3 is representative of a body of a device being secured within the shell 100. Device 302 abuts an inside surface of tab 202 during securement of the shell 100 around the device 302 which causes the side wall of first housing 102 to flex outwardly from a destressed position in the direction of arrow 304 when receiving tab 202 of the second housing 104. Once the tab 202 passes the ledge 300 and enters the recess 204, the side wall of the first housing 102 can de-flex and return to its original position. The contact between tab 202 and the ledge 300 prevents the second housing 104 from disengaging and sliding away from the first housing 102. The installation of the device into the shell 100 prevents the receiving tab 202 of the first housing 102 from disengaging accidentally from recess 204 of the second housing 104 as it prevents the second housing 104 away from the first housing 102.

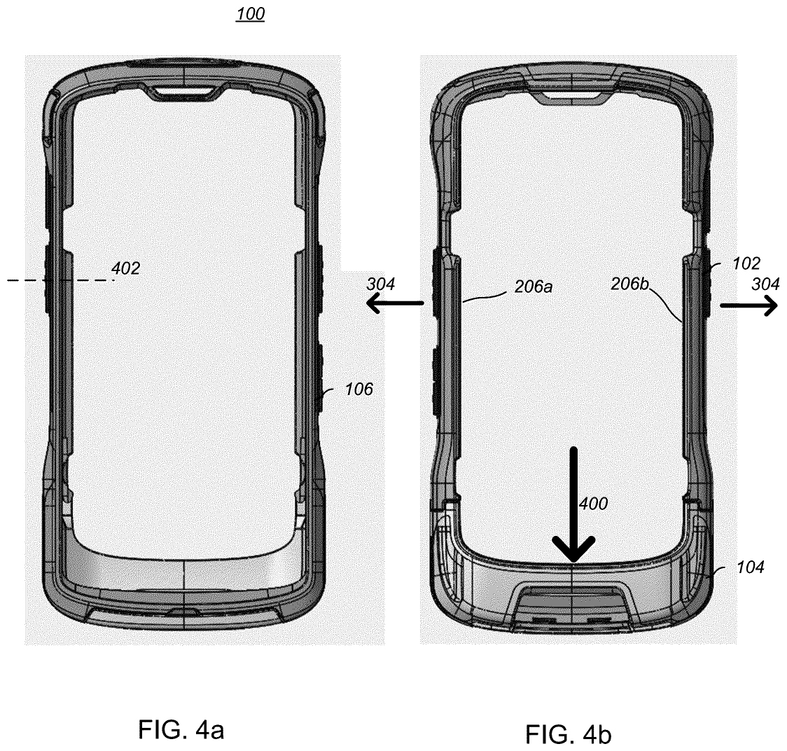

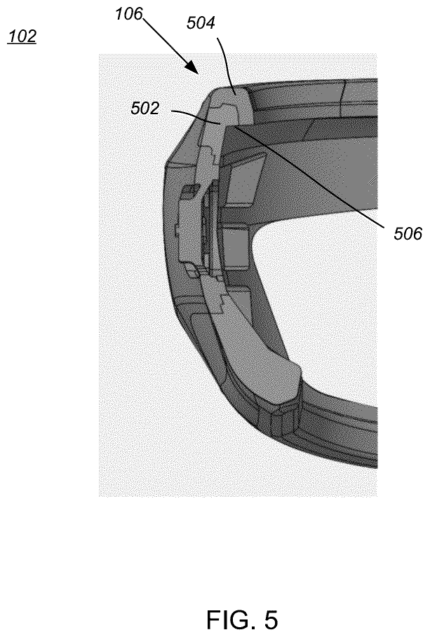

FIGS. 4A and 4B depict a front view and a rear view of the shell 100, respectively. FIG. 4A illustrates a front perimeter edge 106. The front perimeter edge 106 comprises a unitary structure to provide additional rigidity to the shell 100. In other words, the front perimeter edge 106 is one continuous, unbroken piece. The front perimeter edge 106 is continuous around the front side of the shell 100. As is shown in FIG. 5 and described in further detail below, the edge 106 is configured to protect the user interface of the device during front drops. In another embodiment, the front perimeter edge 106 is continuous around the rear side of the shell 100 and is configured to protect the rear of a device.

FIG. 1 further shows the first housing 102 and the second housing 104 forming the shell 100. As shown, when connected to form the shell 100, the first housing 102 and the second housing 104 form a continuous perimeter wall around the device. In other words, in an embodiment, the first housing 102 and the second housing 104 combine to form a rigid protective wall around the sides of the device.

FIG. 5 shows a cross-section of the first housing 102 at line 402 in FIG. 4A. As shown in FIG. 5, the front perimeter edge 106 retains the front of the device. As shown in FIG. 5, the first housing 102 is formed of a first material 502 and a second material 504, where the second material 504 is positioned as a buffer for the shell 100. In one embodiment, the first material 502 of the shell 100 is a rigid durable plastic, which allows for shock protection with minimal wear and tear on the shell 100. In an embodiment, the second material 504 of the shell 100 is rubber to allow for malleability within the structure of the shell when installing and removing the device. However, a problem with using a rubber flexible section is that the rubber insert, over the lifespan of the exoskeleton, becomes deformed due to absorption of cleaning chemicals and hand oils and weak due to flexing and weathering needed to install the device in the exoskeleton and removal of the device. The continuous plastic ring encircling the device and dual housing construction of the disclosure allows for a more rigid and durable design over the lifetime of the shell 100 because it does not stretch or deform with use and can be easily installed and removed from the device. Rubber is used only for added shock absorption and not to provide flexibility or stretching.

As illustrated in FIG. 4B, the shell 100 may need to be removed from the device. When removing the shell 100, the second housing 104 needs to be disengaged from the first housing 102. To do this, the user may apply a force (for example, pulling with thumbs) to an area 206 of the side wall 220. The force from the user against the areas 206 causes the first housing 102 to flex outwardly in the direction of arrows 304 which is away from the device secured in the shell 100. When the side wall 220 of the first housing 102 is properly deflected such that the ledge 300 disengages from the tab 202, the second housing 104 may slide away from the first housing 102 in the direction as indicated by arrow 400. It is important to note that due to the complementary guide rails located in the first housing 102 and the second housing 104, the second housing 104 is removed in the direction indicated and is unable to be pulled away in a different direction.

Most exoskeleton shells have a tradeoff between being able to provide 360-degree protection around the front and sides of the device and being flexible enough to be easily removable. While the visible portion of edge 106 uses rubber for shock absorption, the rubber sections are an overlay for the side walls 220 which include a full 360-degrees of plastic protection internal to the shell 100 which passes around the device. The plastic material provides rigidity to the shell 100 so that the shell 100 does not stretch/deform during use by maintaining the structural integrity of the shell 100.

FIG. 5 further shows a continuous ring 506 wherein the edge 106 travels the perimeter of the continuous ring 506. The continuous ring 506 is around a front perimeter of the device and is a restraining element that abuts the device when the device is within the shell 100. The continuous ring 506 further provides protection to the device during drops or shocks.

Full plastic perimeters around the device have been difficult to implement because the plastic may not be flexible enough for installation/removal of the shell 100 or the plastic may have to be bent to enable installation (likely damaging the shell). Some designs may have included breaks in the plastic that are filled by rubber sections which compensate on the flexibility of the shell to allow for easy assembly. However, these rubber sections do not have sufficient annular support from the plastic as they are highly prone to deforming over time due to repetitive use and exposure to chemicals such as cleaners or oils produced by a user's hands. Once the rubber within a design type with rubber flexible sections becomes permanently deformed, the exoskeleton shell may no longer fit on the device.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

That which is claimed:

1. A protective shell for a device, the protective shell comprising:
a first housing comprising:
a front perimeter edge,
a side wall adjacent to the front perimeter edge,
at least one recess area adjacent to a ledge, and
at least one guide rail; and
a second housing comprising at least one tab and at least one receiving rail;
wherein the first housing and the second housing combine to secure the device by:
meshing the at least one guide rail and the at least one receiving rail, and
securing the at least one tab to the ledge such that the tab is located within the at least one recess area.

2. The protective shell of claim 1, wherein the at least one guide rails and the at least one receiving rail are complementary and interlace such that they are interlaced and slide together when the first housing, and the second housing slide together.

3. The protective shell of claim 1, wherein the first housing comprises a continuous ring of a uniform material.

4. The protective shell of claim 1, wherein the first housing deforms outwardly from a center of the first housing when receiving the second housing.

5. The protective shell of claim 1, further comprising an area on the side wall of the first housing such that the first housing may be gripped and flexed outwardly to allow removal of the second housing from the first housing.

6. The protective shell of claim 1, wherein the first housing includes button elements that allow the user to access buttons on an installed device while using the device is enclosed within the shell.

7. The protective shell of claim 1, wherein the second housing comprises guidance rails that allow a device within the shell to mesh with additional structures.

8. The protective shell of claim 1, wherein the front perimeter edge is continuous and unbroken around the front side of the device.

9. The protective shell of claim 1, wherein the first housing and the second housing are configured to form a continuous perimeter wall around the device, the continuous perimeter wall comprising a rigid material.

10. A shell to protect a device, the shell comprising:
a first housing surrounding a front display of the device; and
a second housing configured to releasably connect to the first housing such that the device is secured within the shell when the second housing is connected to the first housing.

11. The shell of claim 10, wherein the first housing comprises a first set of guide rails;
the second housing comprises a second set of guide rails; and
the first set of guide rails and the second set of guide rails are aligned during the connection of the first housing and the second housing.

12. The shell of claim 10, wherein:
the second housing comprises at least one tab;
the first housing comprises at least one ledge; and
during connection between the first housing and the second housing, the at least one tab of the second housing secures to the at least one ledge of the first housing.

13. The shell of claim 10, wherein the first housing is configured to receive the device.

14. The shell of claim 10, wherein the first housing surrounds the front display of the device with a continuous ring retaining the device within the shell, the continuous ring being molded from the same uniform material throughout.

15. The shell of claim 14, wherein a second material is layered on the first housing.

16. The shell of claim 15, wherein the first material is plastic and the second material is rubber.

17. The shell of claim 10, wherein the first housing deforms outwardly from a center of the first housing when receiving the second housing.

18. The shell of claim 10, further comprising an area on a side wall of the first housing such that the first housing may be gripped and flexed outwardly at the area on the side wall to allow removal of the second housing from the first housing.

19. The shell of claim 10, wherein the first housing comprises an opening for a field of view of a scan window.

20. The shell of claim 10, wherein the first housing and the second housing are configured to form a continuous perimeter wall around the device, the continuous perimeter wall comprising a rigid material.
